(19) United States
(12) Patent Application Publication
(10) Pub. No.: US 2009/0015198 A1
(43) Pub. Date: Jan. 15, 2009

(54) Docking and charging station and method for a portable electronic device

(75) Inventor: Kyle Brandenburg, Philadelphia, PA (US)

Correspondence Address: LERNER GREENBERG STEMER LLP, P O BOX 2480, HOLLYWOOD, FL, 33022-2480, US

(73) Assignee: Marware, Inc.

(21) Appl. No.: 11/825,794

(22) Filed: Jul. 9, 2007

(51) Int. Cl. H02J 7/00; H02J 7/02

(52) U.S. Cl. 320/115

(57) ABSTRACT

A docking and charging station for a portable electronic device includes an AC charging piece for connection to an AC power source, a DC charging piece for connection to a DC power source and a docking piece for receiving the portable electronic device. The docking piece is configured to be coupled to either of the charging pieces in multiple orientations. A method for docking and charging a portable electronic device is also provided.

### BACKGROUND OF THE INVENTION

1. Field of the Invention

The invention relates to a docking and charging station for a portable electronic device, such as an iphone by Apple, although other portable digital media players, such an iPod, may be docked and charged therein as well. The invention also relates to a method for docking and charging a portable electronic device.

2. Description of the Related Art

Apple Inc. manufactures a power adapter for Apple laptop computers, which is in the form of a brick with a detachable plug module. A post on the brick is to be coupled into a cutout in the plug module or an extension cord may be plugged into the brick for AC power.

The power adapter is not a dock for simultaneously holding and charging a device, nor can it hold a device in different orientations, nor can it be used with a vehicle accessory outlet.

### SUMMARY OF THE INVENTION

It is accordingly an object of the invention to provide a docking and charging station and method for a portable electronic device, which overcome the hereinafore-mentioned disadvantages of the heretofore-known devices and methods of this general type and which are able to simultaneously hold and charge a portable electronic device for AC or DC power in different orientations and provide optional signal transmission.

With the foregoing and other objects in view there is provided, in accordance with the invention, a docking and charging station for a portable electronic device. The docking and charging station comprises an AC charging piece for connection to an AC power source, a DC charging piece for connection to a DC power source and a docking piece for receiving the portable electronic device. The docking piece is configured to be coupled to either of the charging pieces in multiple orientations. Therefore, through the use of the invention, one docking piece can be used with both an AC charging piece and a DC charging piece and the pieces can be coupled into multiple orientations as needed from time to time. The configurations are expediently a horizontal and an L-shaped configuration. An upper surface of the docking piece has a receptacle formed therein for receiving and electrically connecting the portable electronic device.

In accordance with another feature of the invention, the charging pieces each have a beveled surface, the docking piece has a beveled surface, and the docking and charging pieces are mutually rotatable for coupling in the horizontal or L-shaped orientations with the beveled surface of the docking piece contacting the beveled surface of one of the charging pieces. The beveled surfaces provide a simple way of aligning the pieces in the different configurations.

In accordance with a further feature of the invention, the beveled surface of one of the docking and charging pieces has posts projecting therefrom to be locked into cutouts at least partially formed in the beveled surface of the other of the docking and charging pieces. This configuration securely locks the pieces together.

In accordance with an added feature of the invention, the beveled surface of one of the docking and charging pieces has pads disposed thereon to be electrically contacted by contacts protruding from the beveled surface of the other of the docking and charging pieces. The electrical contact is provided automatically when the posts and cutouts lock the pieces together.

In accordance with an additional feature of the invention, the AC charging piece has plug prongs for insertion into an AC electrical outlet. The plug prongs swivel into and out of a depression formed in the AC charging piece. The DC charging piece has a plug for connection to a vehicle accessory outlet. The DC charging piece has a body with a socket formed therein, and the plug has a ball rotatable in the socket.

In accordance with yet another feature of the invention, a power cord and/or a signal transmission line are connected to the AC charging piece.

In accordance with yet a further feature of the invention, cushions are disposed on lower surfaces of the docking and charging pieces.

With the objects of the invention in view, there is also provided a method for docking and charging a portable electronic device. The method comprises providing an AC charging piece for connection to an AC power source, a DC charging piece for connection to a DC power source and a docking piece for receiving the portable electronic device. The docking piece is coupled to either of the charging pieces in multiple orientations, such as a horizontal or an L-shaped orientation.

Other features which are considered as characteristic for the invention are set forth in the appended claims.

Although the invention is illustrated and described herein as embodied in a docking and charging station and method for a portable electronic device, it is nevertheless not intended to be limited to the details shown, since various modifications and structural changes may be made in the invention without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, front-elevational view of a docking piece of a docking and charging station for a portable electronic device, according to the invention;

FIGS. 2, 3, 4 and 5 are respective top-plan, side-elevational, bottom-plan and perspective views of the docking piece according to FIG. 1;

FIGS. 6, 7, 8, 9, 10 and 11 are respective front-perspective, top-perspective, side-elevational, bottom-plan, side-elevational and perspective views of an AC charging piece for connection to an electrical outlet;

FIGS. 12 and 13 are respective exploded, perspective and partly broken-away side-elevational views of the docking and AC charging pieces prior to assembly into a table-top or horizontal orientation;

FIGS. 14 and 15 are respective front-side perspective and rear-side perspective views of the docking and AC charging pieces after assembly into the table-top or horizontal orientation, with a portable electronic device in a receptacle;

FIGS. 16 and 17 are respective exploded, perspective and partly broken-away side-elevational views of the docking and AC charging pieces prior to assembly into a wall-mount or L-shaped orientation;

FIG. 18 is a front-side perspective view of the docking and AC charging pieces after assembly into the wall-mount or L-shaped orientation, with the portable electronic device in the receptacle and prior to plugging into an electrical wall outlet;

FIGS. 19, 20, 21 and 22 are respective top-perspective, perspective, front-perspective and side-elevational views of a DC charging piece for connection to a vehicle accessory outlet;

FIGS. 23 and 24 are respective exploded, perspective views of the docking and DC charging pieces prior to assembly into a horizontal orientation;

FIGS. 25 and 26 are respective exploded, perspective views of the docking and DC charging pieces prior to assembly into an L-shaped orientation;

FIG. 27 is a perspective view of the docking and DC charging pieces after assembly into the L-shaped orientation, with the portable electronic device in the receptacle; and

FIG. 28 is a perspective view of the docking and DC charging pieces after assembly into the horizontal orientation, with the portable electronic device in the receptacle.

### DESCRIPTION OF THE PREFERRED EMBODIMENTS

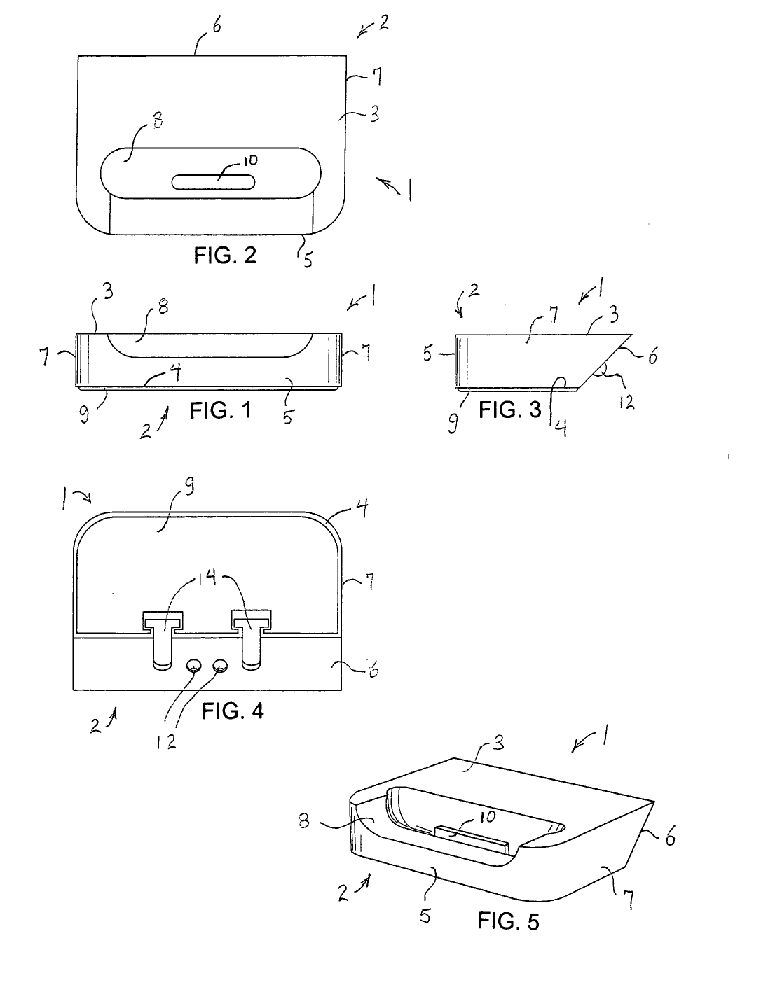

Referring now to the figures of the drawings in detail and first, particularly, to FIGS. 1-5 thereof, there is seen a docking piece 1 of a docking and charging station according to the invention. The docking piece 1 includes a body 2 having an upper surface 3, a lower surface 4, a front surface 5, a rear surface 6 and side surfaces 7. The upper surface 3 has a cutout formed therein in the shape of a receptacle 8 for receiving, docking and charging a portable electronic device, such as an iPhone by Apple, although other portable digital media players, such an iPod, may be docked and charged therein as well. A plug 10 within the receptacle 8 is inserted into a corresponding cutout in the phone or media player for making an electrical connection. A cushion 9, which may be formed of silicone rubber, covers the lower surface 4 of the body 2. It may be seen that the rear surface 6 of the body 2 is beveled and has rounded contacts 12 protruding therefrom, which may be spring-biased outwardly. The lower surface 4 and the rear surface 6 also have T-shaped cutouts 14 formed therein. The purpose of the contacts 12 and the cutouts 14 will be explained below.

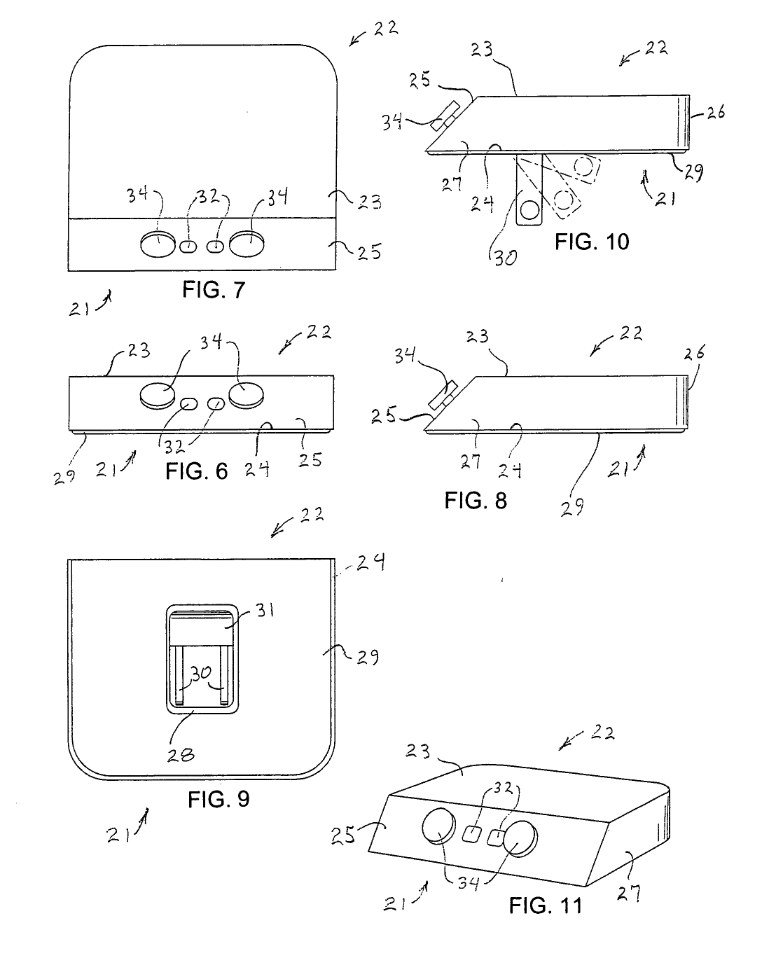

FIGS. 6-11 illustrate an AC charging piece 21 of the docking and charging station, for cooperating with the docking piece 1. The AC charging piece 21 includes a body 22 having an upper surface 23, a lower surface 24, a front surface 25, a rear surface 26 and side surfaces 27. The front surface 25 is beveled and has two T-shaped posts 34 projecting therefrom corresponding in size and shape to the T-shaped cutouts 14 formed in the lower surface 4 and the rear surface 6 of the body 2 of the docking piece 1. Two pads 32 are intended to be contacted by the rounded contacts 12 protruding from the rear surface 6 of the body 2. A silicone rubber cushion 29 covers the lower surface 24 of the body 22. It may be seen from FIG. 9 that a depression 28 is formed in the lower surface 24. Two plug prongs 30 for insertion into an AC electrical outlet are disposed on a swivel base 31 so that the plug prongs 30 can be pivoted as shown in FIG. 10.

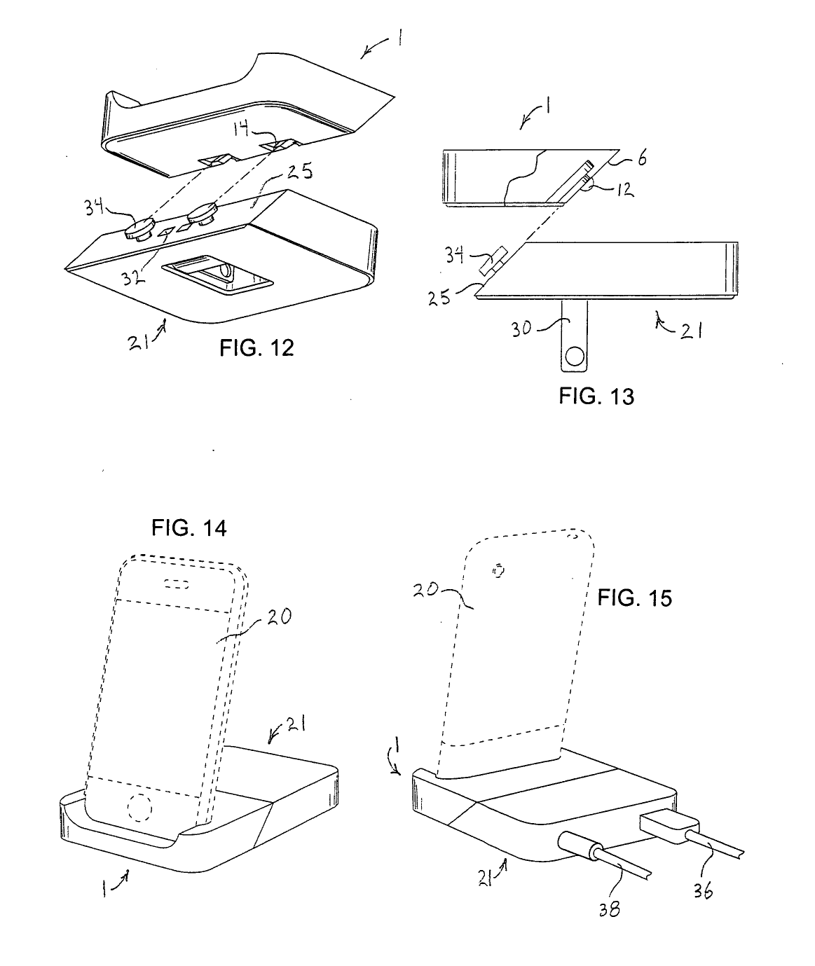

FIGS. 12 and 13 illustrate how the docking piece 1 and the AC charging piece 21 may be coupled together by sliding the T-shaped posts 34 into the T-shaped cutouts 14, causing the contacts 12 to contact the pads 32. FIGS. 14 and 15 show the assembled docking and AC charging pieces 1, 21 of the docking and charging station in a table-top or horizontal orientation, with a portable electronic device such as an iPhone 20 in the receptacle 8. The alignment of the beveled surfaces 6, 25 as shown provides the horizontal orientation. In this orientation, the plug 10 within the receptacle 8 is inserted into a corresponding cutout in the portable electronic device 20. In addition, in this orientation, the cushions 9, 29 may rest on a flat surface. In this case, electrical power is supplied to the portable electronic device 20 through a power cord 36 and signals may be transmitted through a signal line 38. Alternatively, the prongs 30 may be extended, so as to be inserted into an outlet of a power strip.

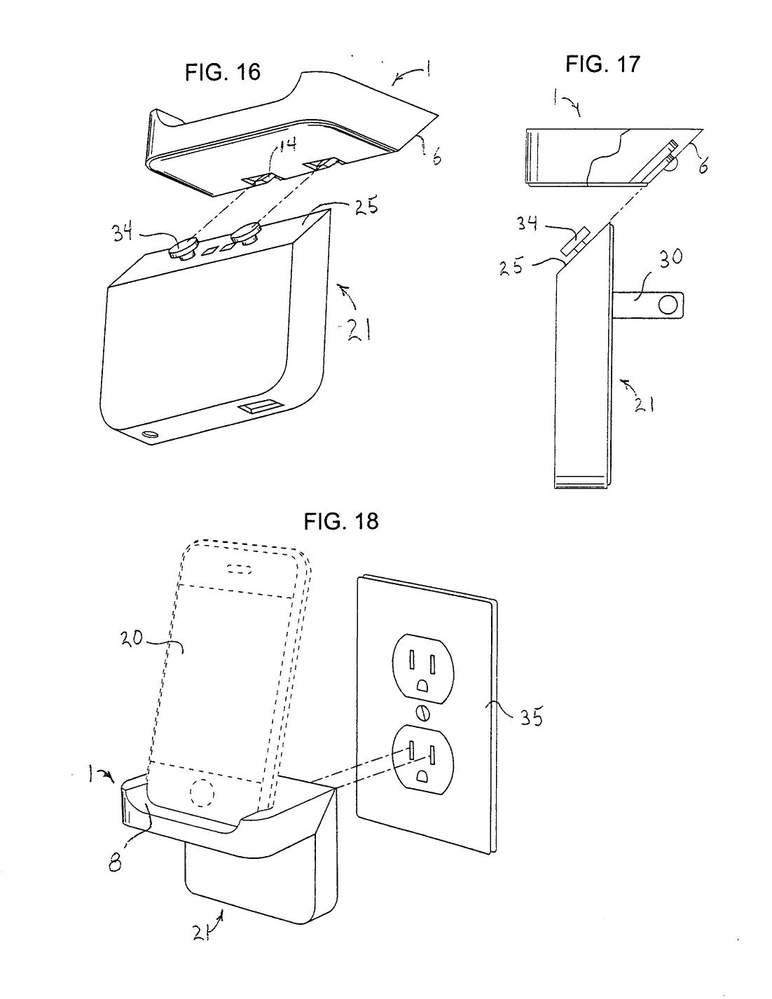

FIGS. 16 and 17 illustrate how the docking piece 1 and the AC charging piece 21 may also be coupled together with the AC charging piece 21 rotated through 180° and oriented vertically as compared to FIGS. 12 and 13. A wall-mount or L-shaped orientation shown in FIG. 18 is provided by the beveled surfaces 6, 25, each of which form an angle of 45° with the upper surface of a respective one of the pieces 1, 21. This orientation is maintained by the T-shaped posts 34 and cutouts 14. Once again, the contacts 12 contact the pads 32. The portable electronic device 20 is disposed in the receptacle 8 and the prongs 30 may be plugged into an electrical wall outlet 35.

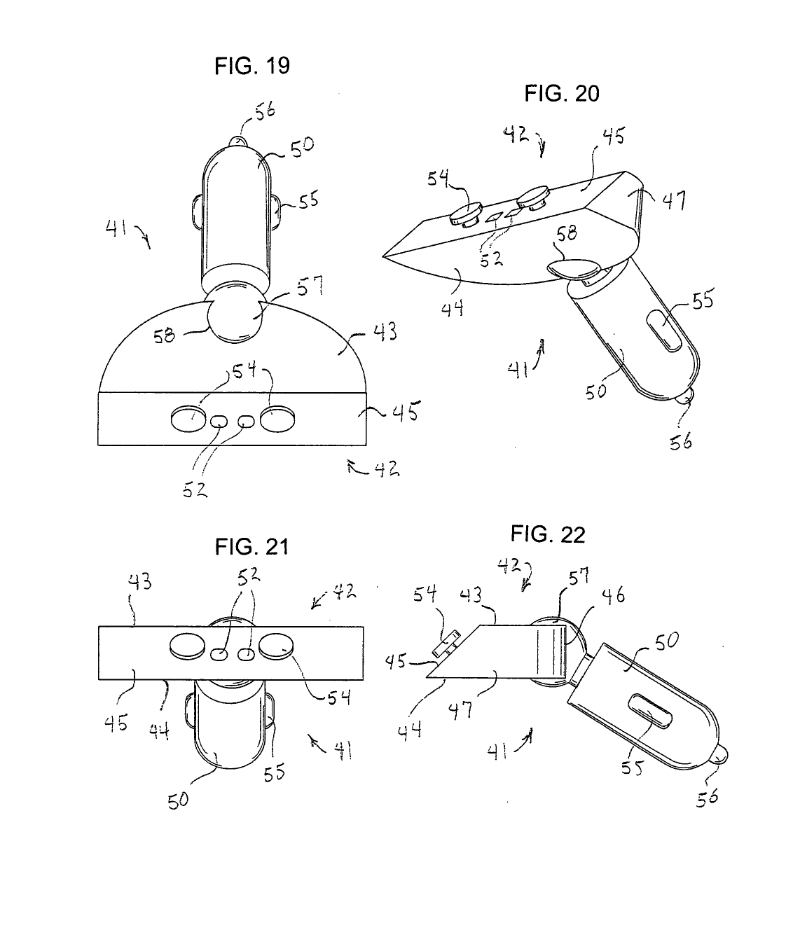

FIGS. 19-22 show a DC charging piece 41 for connection to a vehicle accessory or cigarette lighter outlet. The DC charging piece 41 is to be used in cooperation with the docking piece 1 as an alternative to the AC charging piece 21. The DC charging piece 41 includes a body 42 having an upper surface 43, a lower surface 44, a front surface 45, a rear surface 46 and side surfaces 47. The front surface 45 is beveled and has two T-shaped posts 54 projecting therefrom corresponding in size and shape to the T-shaped cutouts 14 formed in the lower surface 4 and the rear surface 6 of the body 2 of the docking piece 1. Two pads 52 are intended to be contacted by the rounded contacts 12 protruding from the rear surface 6 of the body 2.

Instead of prongs for an electrical wall outlet, a plug 50 for insertion into a vehicle accessory outlet is provided. The plug 50 has prongs 55, 56 for making electrical connections within the vehicle accessory outlet. The plug 50 has a ball 57 which swivels in a socket 58 in the body 42 so as to permit the body 42 and the plug 50 to be moved relative to each other.

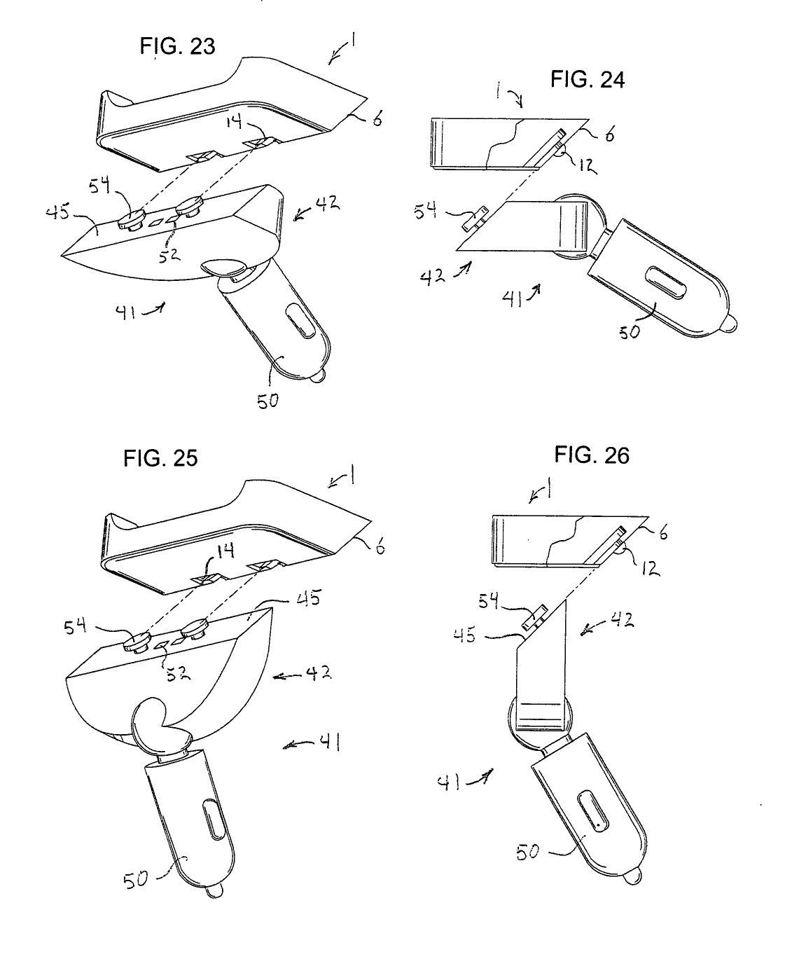

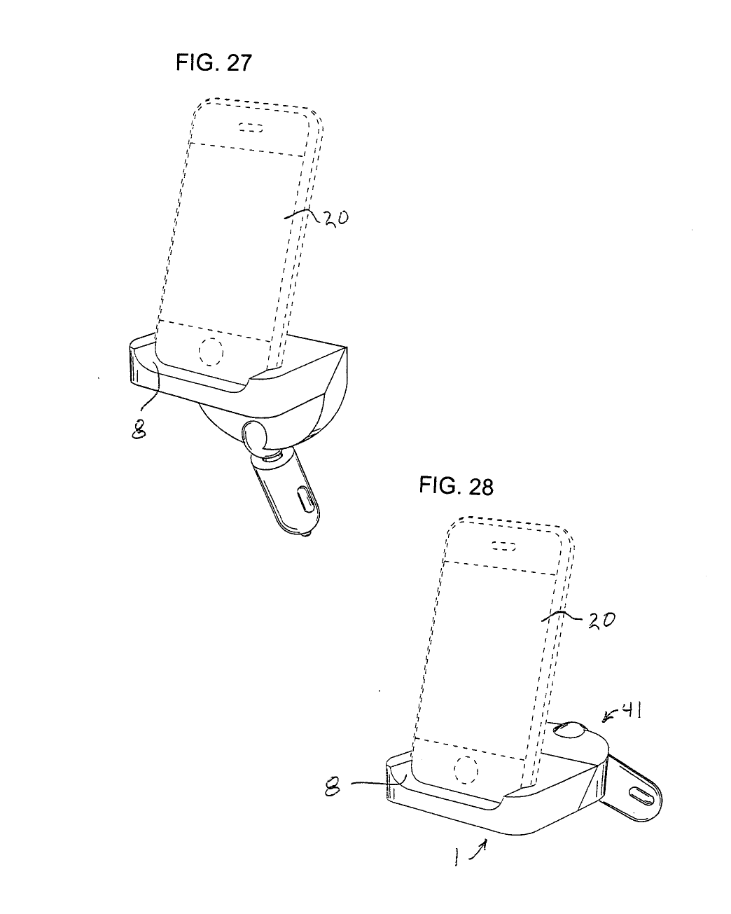

FIGS. 23 and 24 show the docking piece 1 and the body 42 of the DC charging piece 41 prior to assembly into a horizontal orientation. The docking piece 1 and the DC charging piece 41 may be coupled together by sliding the T-shaped posts 54 into the T-shaped cutouts 14, causing the contacts 12 to contact the pads 52. FIG. 28 shows the assembled docking and DC charging pieces 1, 41 of the docking and charging station in the horizontal orientation, with the portable electronic device 20 in the receptacle 8. The alignment of the beveled surfaces 6, 45 as shown provides the horizontal orientation.

FIGS. 25 and 26 show the docking piece 1 and the body 42 of the DC charging piece 41 prior to assembly into an L-shaped orientation. The DC charging piece 41 is rotated through 180° and oriented vertically as compared to FIGS. 23 and 24. The L-shaped orientation seen in FIG. 27 is provided by the beveled surfaces 6, 45 and maintained by the T-shaped posts 54 and cutouts 14. Once again, the contacts 12 contact the pads 52.

The horizontal and L-shaped orientations are chosen in dependence on the location and accessibility of the accessory outlet in a particular vehicle. The plug 50 is simply pivoted as needed due to the ball and socket configuration 57, 58.

I claim:

1. A docking and charging station for a portable electronic device, the docking and charging station comprising:
an AC charging piece for connection to an AC power source;
a DC charging piece for connection to a DC power source; and
a docking piece for receiving the portable electronic device, said docking piece being configured to be coupled to either of said charging pieces in multiple orientations.

2. The docking and charging station according to claim 1, wherein said multiple orientations includes a horizontal and an L-shaped orientation.

3. The docking and charging station according to claim 2, wherein said charging pieces each have a beveled surface, said docking piece has a beveled surface, and, said docking and charging pieces are mutually rotatable for coupling in said horizontal or L-shaped orientations with said beveled surface of said docking piece contacting said beveled surface of one of said charging pieces.

4. The docking and charging station according to claim 3, wherein said beveled surface of one of said docking and charging pieces has posts projecting therefrom to be locked into cutouts at least partially formed in said beveled surface of the other of said docking and charging pieces.

5. The docking and charging station according to claim 4, wherein said beveled surface of one of said docking and charging pieces has pads disposed thereon to be electrically contacted by contacts protruding from said beveled surface of the other of said docking and charging pieces.

6. The docking and charging station according to claim 1, wherein said AC charging piece has plug prongs for insertion into an AC electrical outlet.

7. The docking and charging station according to claim 1, wherein said plug prongs swivel into and out of a depression formed in said AC charging piece.

8. The docking and charging station according to claim 1, wherein said DC charging piece has a plug for connection to a vehicle accessory outlet.

9. The docking and charging station according to claim 1, wherein said DC charging piece has a body with a socket formed therein, and said plug has a ball rotatable in said socket.

10. The docking and charging station according to claim 1, wherein said docking piece has an upper surface with a receptacle formed therein for receiving and electrically connecting the portable electronic device.

11. The docking and charging station according to claim 1, which further comprises a power cord connected to said AC charging piece.

12. The docking and charging station according to claim 1, which further comprises a signal transmission line connected to said AC charging piece.

13. The docking and charging station according to claim 1, which further comprises cushions each being disposed on a lower surface of a respective one of said docking and charging pieces.

14. A method for docking and charging a portable electronic device, the method comprising the following steps:
providing an AC charging piece for connection to an AC power source;
providing a DC charging piece for connection to a DC power source; and
providing a docking piece for receiving the portable electronic device; and
coupling the docking piece to either of the charging pieces in multiple orientations.

15. The method according to claim 14, which further comprises carrying out the coupling step by coupling the docking piece to either of the charging pieces in a horizontal or an L-shaped orientation.

16. The method according to claim 15, which further comprises providing each of the charging pieces with a beveled surface, providing the docking piece with a beveled surface, and mutually rotating the docking and charging pieces for coupling in the horizontal or L-shaped orientations with the beveled surface of the docking piece contacting the beveled surface of one of the charging pieces.

17. The method according to claim 16, which further comprises locking the docking and charging pieces together by engaging posts projecting from the beveled surface of one of the docking and charging pieces into cutouts at least partially formed in the beveled surface of the other of the docking and charging pieces.

18. The method according to claim 17, which further comprises electrically contacting pads disposed on the beveled surface of one of the docking and charging pieces with contacts protruding from the beveled surface of the other of the docking and charging pieces.

19. The method according to claim 14, which further comprises swiveling plug prongs out of a depression formed in the AC charging piece for insertion into an AC electrical outlet.

20. The method according to claim 14, which further comprises providing the DC charging piece with a body having a socket formed therein and a vehicle accessory plug having a ball disposed thereon to be rotated in the socket.
